(19) United States
(12) Patent Application Publication
(10) Pub. No.: US 2013/0320116 A1
(43) Pub. Date: Dec. 5, 2013

(54) MAGNETIC ARRAY FOR COUPLING FLUID DELIVERY COMPONENTS

(71) Applicants: Patrick B. Jonte, Zionsville, IN (US); Brian Johnson, Muncie, IN (US)

(72) Inventors: Patrick B. Jonte, Zionsville, IN (US); Brian Johnson, Muncie, IN (US)

(21) Appl. No.: 13/482,605

(22) Filed: May 29, 2012

(51) Int. Cl. B05B 1/00

(52) U.S. Cl. 239/600

(57) ABSTRACT

A fluid delivery device and a docking base are releasably coupled together by a magnetic coupling including a magnetic array and a magnetically attractive element. The magnetic array illustratively comprises a Halbach array. The fluid delivery device may comprise a pullout spray head, and the docking base may comprise a spout, a faucet body, or any other device suitable for holding the spray head. According to another illustrative embodiment, the fluid delivery device may comprise a hand shower removably coupled to a shower head or other docking base.

### BACKGROUND AND SUMMARY OF THE INVENTION

The invention relates generally to fluid delivery devices and, more particularly, to improvements in the coupling of components of fluid delivery devices.

Fluid delivery devices that are removable from a docking base enable users to aim a water spray directly at a target instead of requiring the user to position the target under the fluid delivery device. Fluid delivery devices and docking bases utilizing a magnetic coupling provide a retaining force between the device and the docking base that may be overcome by physical force exerted by the user. Exemplary fluid delivery devices and docking bases utilizing a magnetic coupling include faucets having pullout sprayheads, such as those disclosed in U.S. Pat. Nos. 7,753,079 and 7,909,061, and handshowers removably coupled to a fixed shower, such as that disclosed in U.S. Patent Application Publication No. 2009/0007330, the disclosures of which are herein expressely incorporated by reference.

In an illustrative embodiment, a first faucet component and a second faucet component are coupled together by a magnetic coupling. The magnetic coupling includes a magnetic array in one of the first faucet component and the second faucet component, and a magnetically attractive element in the other of the second faucet component and the first faucet component. In an illustrative embodiment, the first faucet component comprises a docking base, such as a spout or a faucet body, and the second faucet component comprises a fluid delivery device ,such as a pullout sprayhead. In another illustrative embodiment, the fluid delivery device comprises a handshower removably coupled to a fixed showerhead or other docking base.

In one illustrative embodiment, the magnetically attractive element is also a magnet. In another illustrative embodiment, the magnetically attractive element is a material that is attracted to magnets, such as iron or steel. In still another exemplary embodiment, either the magnet, the magnetically attractive element, or both, includes an electromagnet.

In an illustrative embodiment, the magnetic array includes a Halbach array. A Halbach array is an arrangement of magnets that provides an augmented magnetic field on one side of the array and a diminished magnetic field on the opposite side of the array. Halbach arrays are discussed, for example, in U.S. Pat. Nos. 5,631,618 and 5,705,902, the disclosures of which are herein expressly incorporated by reference. In some illustrative embodiments, a Halbach array provides a field of nearly twice the strength as a standard permanent magnet on one side of the field and a field of near zero strength on the opposite side of the field. Use of a Halbach array allows for the use of less magnetic material while maintaining or increasing the strength of the magnetic field compared to standard permanent magnets. Alternatively, the same amount of magnetic material may be used, but the strength of the field on one side of the array can be increased while the strength of the field on the other side of the array can be decreased compared to standard permanent magnets.

In an illustrative embodiment, the magnetic array of the present disclosure includes a linear or flat Halbach array. In a further illustrative embodiment, the magnetic coupling includes an annular Halbach array. In another illustrative embodiment, the magnetic coupling includes a cylinder Halbach array.

In still another illustrative embodiment, the magnetic coupling has at least one aligned position where the magnetic attracting force of the magnetic coupling is at a maximum and a multitude of misaligned positions where the magnetic attracting force is less than the maximum force. In an illustrative embodiment method, the coupling and uncoupling is facilitated by changing the position of the fluid delivery device relative to the docking base to reduce the magnetic force before the fluid delivery device disconnects from the docking base. In one illustrative embodiment, the change in position is accomplished by rotating a coupled fluid delivery device about the centerline of its docking base. In another illustrative embodiment, the change in position is accomplished by tilting a coupled fluid delivery device away from the centerline of the docking base before the fluid delivery device separates from the docking base.

Additional features and advantages of the present invention will become apparent to those skilled in the art upon consideration of the following detailed description of the illustrative embodiment exemplifying the best mode of carrying out the invention as presently perceived.

### BRIEF DESCRIPTION OF THE DRAWINGS

The above-mentioned and other features and objects of this invention, and the manner of attaining them, will become more apparent and the invention itself will be better understood by reference to the following description of embodiments of the invention taken in conjunction with the accompanying drawings, wherein:

FIG. 1 is a perspective view of an illustrative showerhead including a magnetic array of the present disclosure for removably coupling a handshower to the showerhead;

FIG. 2 is a perspective view of the showerhead of FIG. 1, with a partial cut-away to show the magnetic array;

FIG. 3 is a cross-sectional perspective view of the removable handshower and showerhead of FIG. 1, showing the handshower coupled to the showerhead, and showing the position of the magnetic array and magnetically attractive element;

FIG. 4 is a diagrammatic view of a linear Halbach array showing an exemplary orientation pattern of each portion's magnetic field;

FIG. 5 is a magnetic flux diagram of the linear Halbach array of FIG. 4;

FIG. 6 is a side elevational view of an illustrative faucet including a spray head removably coupled to a spout with a magnetic array of the present disclosure;

FIG. 7 is a partial cross-sectional view of the illustrative faucet of FIG. 6;

FIG. 8 is an illustrative top diagrammatic view of an annular Halbach array showing an exemplary orientation pattern of each portion's magnetic field;

FIG. 9 is an illustrative perspective diagrammatic view of the Halbach array of FIG. 6 showing the exemplary orientation pattern;

FIG. 10 is a perspective view of an illustrative faucet with a fluid delivery device removably coupled to a docking base with a magnetic array of the present disclosure;

FIG. 11 is an illustrative top diagrammatic view of the magnetic field of another Halbach array configured to provide an increased magnetic field in the interior of the array and a decreased magnetic field in the exterior of the array; and

FIG. 12 is an illustrative top diagrammatic view of the magnetic field of yet another Halbach array configured to provide an increased magnetic field in the exterior of the array and a decreased magnetic field in the interior of the array.

Corresponding reference characters indicate corresponding parts throughout the several views. Although the drawings represent embodiments of the present invention, the drawings are not necessarily to scale and certain features may be exaggerated in order to better illustrate and explain the present invention. The exemplifications set out herein illustrate embodiments of the invention in several forms and such exemplification is not to be construed as limiting the scope of the invention in any manner.

### DETAILED DESCRIPTION OF THE DRAWINGS

The embodiments discussed below are not intended to be exhaustive or limit the invention to the precise forms disclosed in the following detailed description. Rather, the embodiments are chosen and described so that others skilled in the art may utilize their teachings.

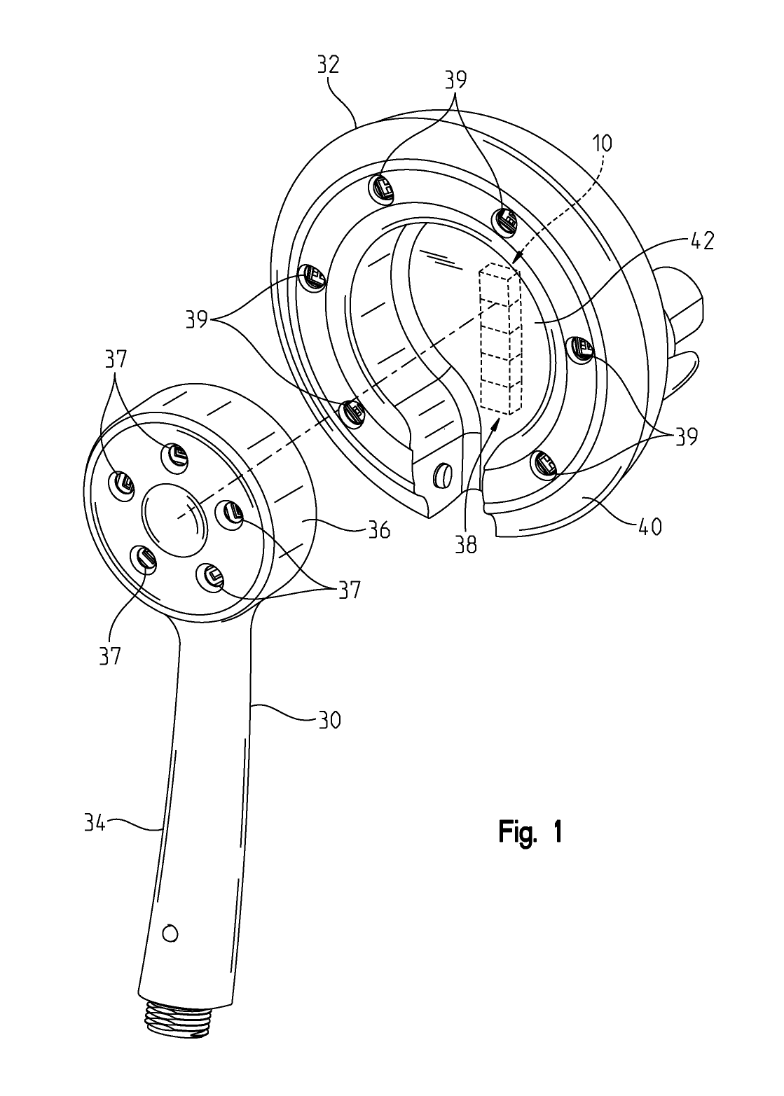

FIG. 1 shows an illustrative fluid delivery device configured to be magnetically coupled to a docking base. In some illustrative embodiments, a magnetic array 10 is used to couple a fluid delivery device, illustratively a hand shower 30, to a docking base, illustratively a shower head 32. Hand shower 30 includes a handle 34 and a spray head 36 supporting fluid outlets, illustratively nozzles or multi-dimensional fluidic devices 37. Shower head 32 includes a center recess 38 partially enclosed by an arcuate housing 40 for receiving hand shower 30. The illustrative housing 40 includes a plurality of fluid outlets, illustratively nozzles or multi-dimensional fluidic devices 39. In the illustrated embodiment, shower head 32 also includes a back wall 42 at a rear end of center recess 38.

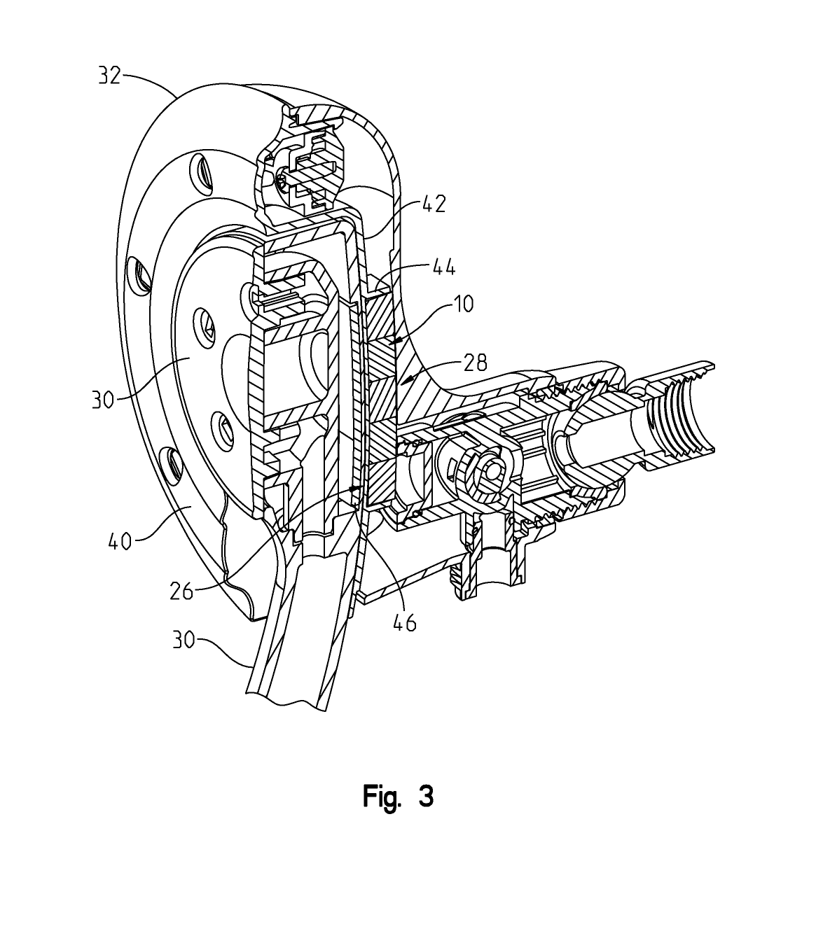

With reference to FIGS. 1-3, a magnetic array 10 is positioned in a mounting area 44 on back wall 42. Magnetic array 10 may be comprised of any number of magnet portions or segments in a pattern producing a strong side and weak side to the array 10. As used herein, magnet portions or segments may comprise individual and discrete magnets, or a single, integrally formed magnet with different magnetically oriented (i.e., polled) portions. Any orientation may be used to start the magnet portion pattern in the array 10. Magnetic array 10 illustratively comprises a Halbach array positioned such that a strong side 26 is oriented forward towards center recess 38 and a weak side 28 is oriented rearward away from center recess 38. This orientation provides the magnetic field from array 10 in center recess 38 (FIGS. 3 and 5). Each magnet portion may be formed of conventional magnetic material, such as ferrite or neodymium.

With further reference to FIG. 3, hand shower 30 includes magnetically attractive element 46. In some embodiments, element 46 may be formed from a magnetically attractive material, such as steel, iron, other known magnetically attractive materials, or mixtures or alloys containing magnetically attractive materials. In other embodiments, element 46 may be a magnet or contain a Halbach array oriented such that a strong side 26 is oriented towards array 10 of shower head 32, and a weak side 28 is oriented away from array 10 of shower head 32, when hand shower 30 is coupled to shower head 32.

When hand shower 30 is positioned within center recess 38 of shower head 32, the magnetic field of array 10 attracts magnetically attractive element 46, forming a magnetic coupling. The force between array 10 and element 46 helps maintain hand shower 30 in center recess of 38. When user wishes to remove hand shower 30 from the shower head 32, she exerts enough force on hand shower 30 to overcome the magnetic force and break the magnetic coupling. Although magnetically attractive element 46 and array 10 are shown positioned on opposite sides of back wall 42 and in center recess 38, other positions are contemplated. In one illustrative embodiment, element 46 is be positioned in handle 34 and array 10 is positioned lower on back wall 42. In another illustrative embodiment, element 46 is positioned circumferentially within spray head 36, and array 10 is circumferentially positioned in arcuate housing 40. In yet still other illustrative embodiments, element 46 is comprised of separate pieces in hand shower 30.

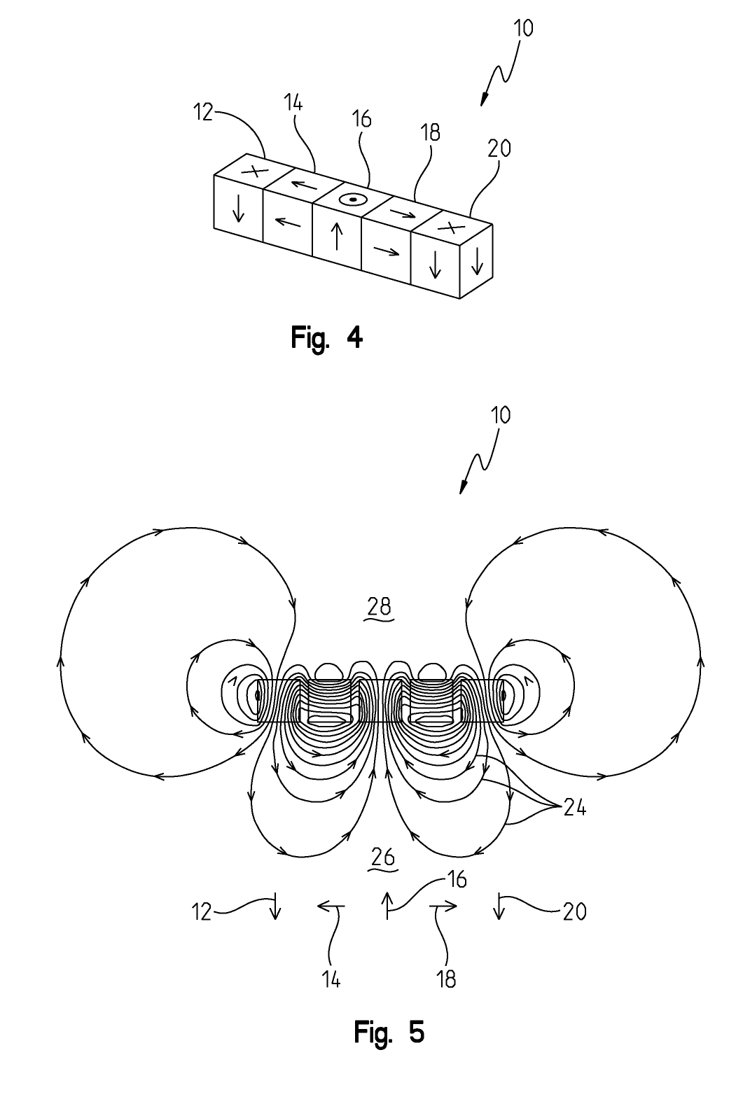

FIG. 4 is a diagram of an exemplary linear Halbach array 10 of the type that may be used in shower head 32. Halbach array 10 is comprised of a plurality of magnet portions or segments 12, 14, 16, 18, 20. Although five magnet portions are shown, additional or fewer magnet portions may be used. Each portion 12, 14, 16, 18, 20 generates a magnet field, the north orientation of which is shown by an arrow. A circle surrounding a dot indicates that the north orientation of the magnetic field is on the labeled face of the portion. An “X” indicates that the south orientation of the magnetic field is on the labeled face of the portion. In the exemplary Halbach array 10 shown, portions 12, 14, 16, 18, 20 are arranged such that the orientation of their magnetic field forms a pattern. Viewed from the left face of array 10 in FIG. 4, the pattern is down (portion 12), left (portion 14), up (portion 16), right (portion 18), and then the pattern begins to repeat with down (portion 20). If additional portions were added to the right of portion 20, they would be added in the orientation of left, followed by up, right, down, and so on maintaining the pattern. The pattern of magnet portions may repeat in this fashion indefinitely. Any of the respective magnet portion orientations may be used as the starting point.

FIG. 5 illustrates the resulting magnetic fields from exemplary Halbach array 10. Array 10 is comprised of portions 12, 14, 16, 18, 20 with the orientation pattern of down, left, up, right, down when viewed from left to right. Magnetic field lines 24 illustrate the relative strength of the resulting magnetic field of Halbach array 10, such that a greater concentration or grouping of field lines 24 corresponds to a stronger magnetic field. As illustrated in FIG. 5, the magnetic field is strong on side 26 below array 10 and the magnetic field is weak on side 28 above array 10. In a further illustrative embodiment, if portions 14 and 18 were switched in position, the magnetic field would be strong above the array 10 and weak below array 10.

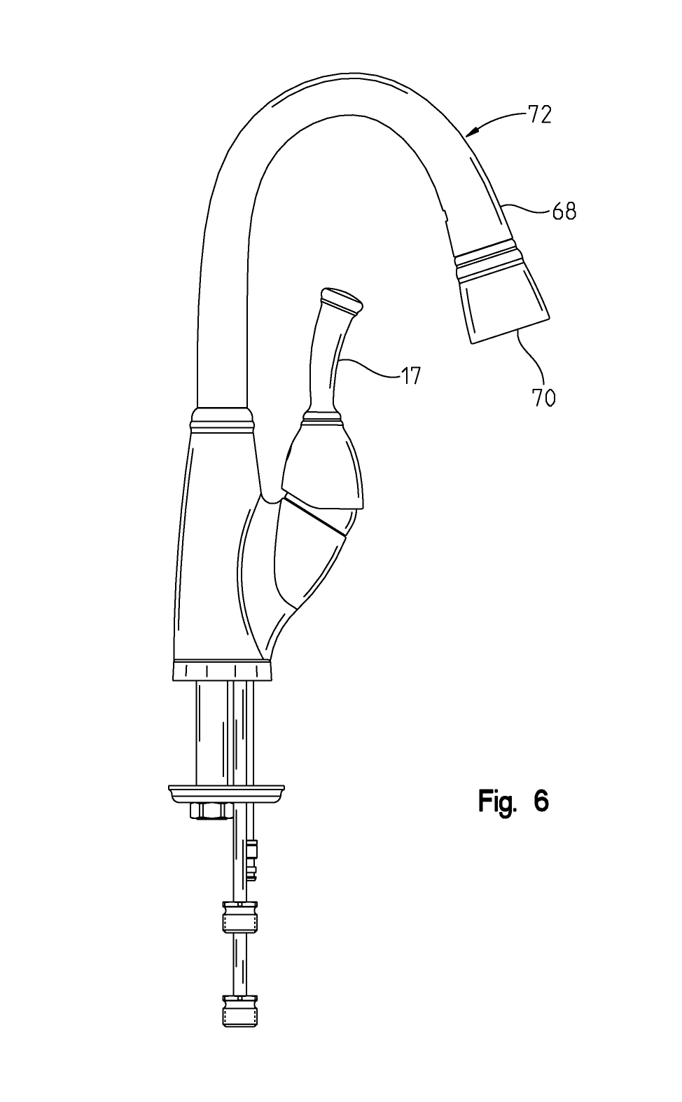

In the exemplary embodiment illustrated in FIG. 6, the fluid delivery device is a spray head 70, and the docking base is a faucet body or delivery spout 72. In the embodiment illustrated in FIG. 6, docking base 72 includes neck 68.

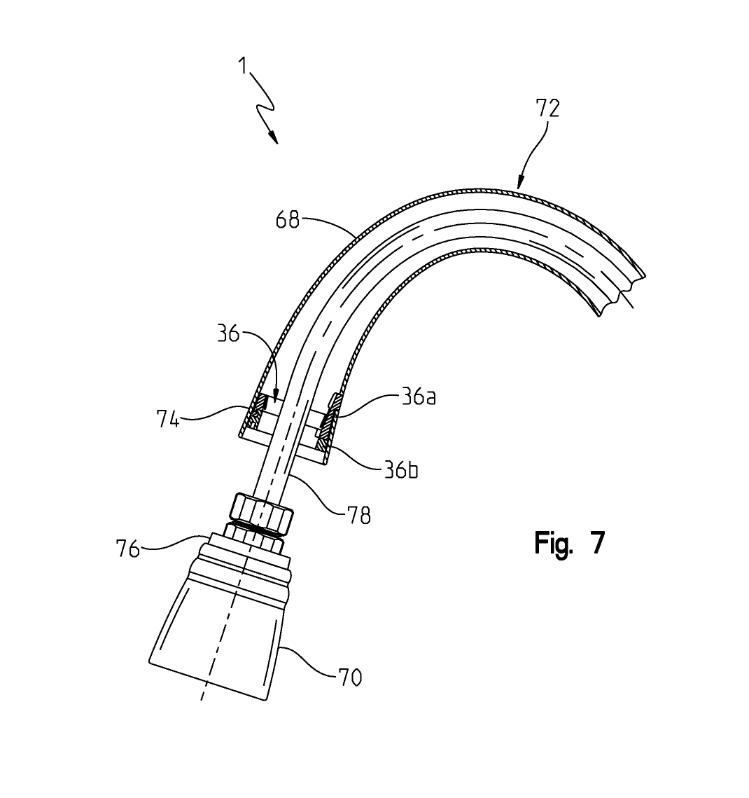

With reference to FIGS. 6 and 7, a base element 74 is supported by neck 68 of delivery spout 72, and a spray head element 76 s supported by spray head 70. In an illustrative embodiment, one of the base element 74 and the spray head element 76 includes a magnetic array, while the other of the spray head element 76 and the base element 74 includes a magnetically attractive element. In another illustrative embodiment, both base element 74 and spray head element 76 include a magnetic array.

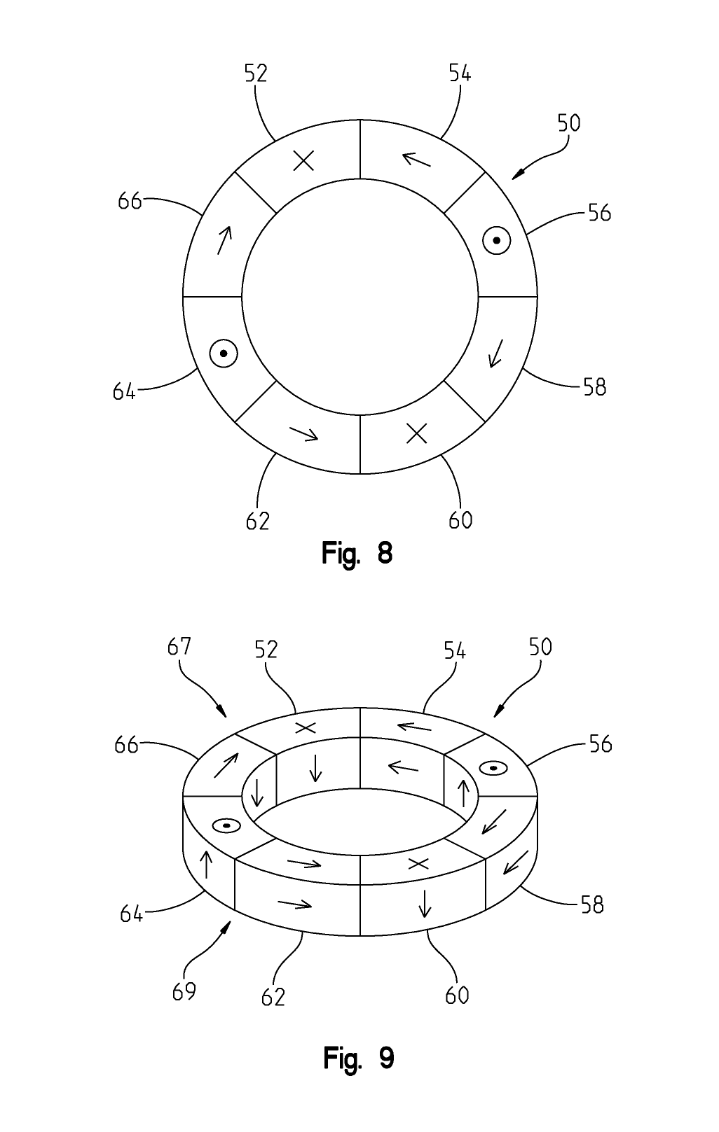

In certain illustrative embodiments, the magnetic array in base element 74 and/or spray head element 76 are annular arrays, such as array 50 shown in FIGS. 8 and 9, although other shaped arrays are also contemplated. The annular array of FIGS. 8 and 9 illustratively include rotating magnetic flux distributions alternating between axial and transverse planes to generate increased magnetic fields in an axial direction toward the other of the base element 74 and spray head element 76.

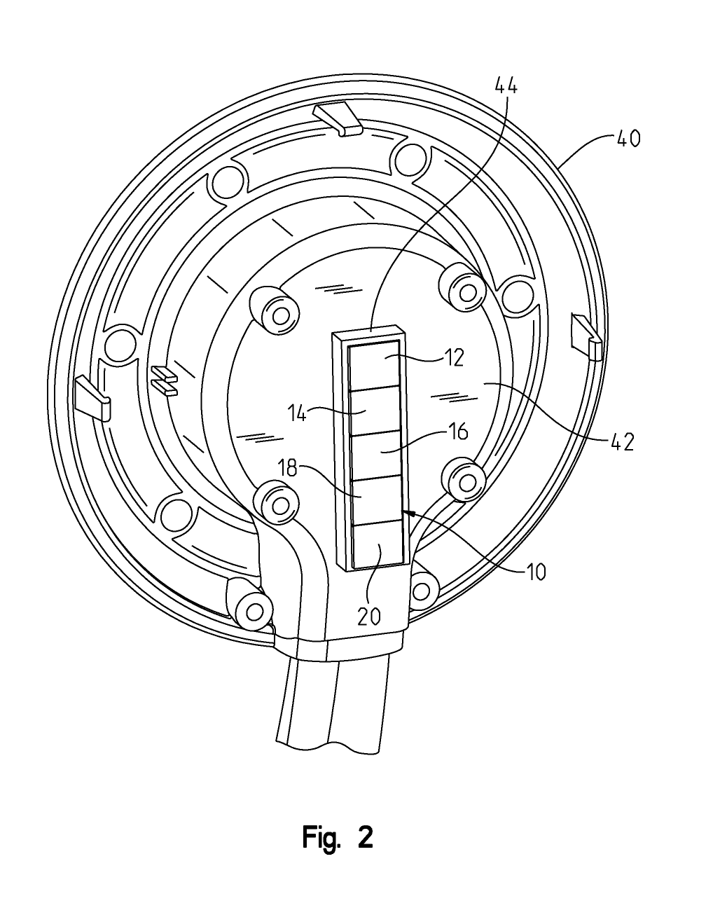

In yet still another illustrative embodiment, the magnetic array in base element 74 and/or spray head element 76 are linear arrays, such as array 10 shown in FIGS. 1 and 2, although other linear and non-linear arrays are also contemplated. The linear array of FIGS. 1 and 2 illustratively includes a plurality of linearly aligned magnet portions including rotating magnetic flux distributions extending in alternating x and y directions to generate increased magnetic fields in a direction toward the other of the base element 74 and spray head element 76.

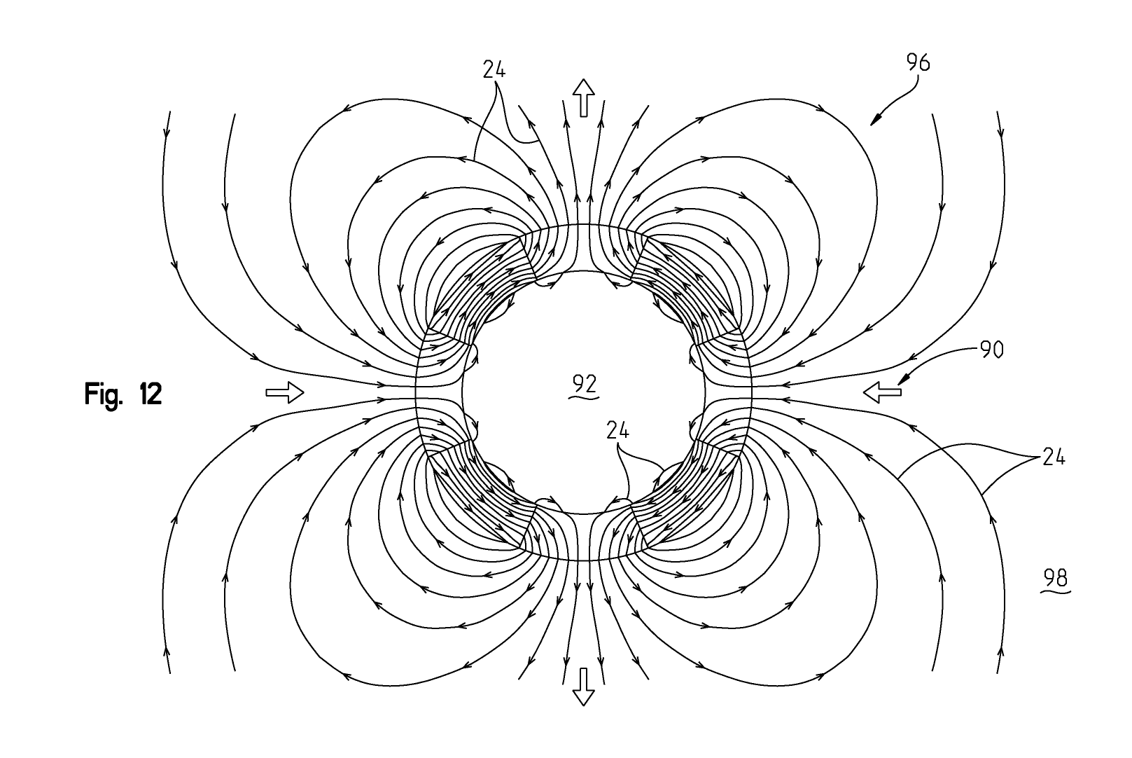

In yet other illustrative embodiments, the magnetic array in either base element 74 or spray head element 76 or both are cylindrical arrays, such as shown in FIGS. 11 and 12, although other various shaped arrays are also contemplated. The cylindrical arrays of FIGS. 11 and 12 illustratively include rotating magnetic flux distributions extending within a transverse plane to generate increased magnetic fields in a transverse direction toward the other of the base element 74 and spray head element 76.

In an illustrative embodiment, either base element 74 or sprayhead element 76 may be at least partially formed from a magnetically attractive material. Such materials may include, but are not limited, to steel, iron, other known magnetically attractive materials, or mixtures or alloys containing magnetically attractive materials.

When a user wishes to remove spray head 70, she exerts enough force on spray head 70 to overcome the magnetic force and remove spray head 70. A fluid supply line, illustratively a tube or hose 78, is attached to spray head 70 and slidably pulls through faucet base 72 and the user can move spray head 70 to a position away from faucet base 72. When the user wishes to return spray head 70 to faucet base 72, she positions spray head 70 such that spray head element 76 and base element 74 magnetically couple and spray head 70 is attached to faucet base 72. Although base element 74 is shown positioned on the interior of neck 68 and spray head element 76 is shown positioned on the top exterior of spray head 70, other locations are contemplated. In another embodiment, base element is on the outside edge of neck 68. In yet another embodiment, spray head element 76 is positioned on the interior of spray head 70. Other locations are also possible depending on the distances and strength of magnets chosen.

FIG. 8 is a diagram of an illustrative annular Halbach array 50 comprised of eight portions or segments 52, 54, 56, 58, 60, 62, 64, 66, each portion having a magnetic field orientation. FIG. 9 is a perspective view of the exemplary orientation of FIG. 8. The orientation of the magnetic field for each portion is as discussed for FIGS. 4 and 5 above. In the illustrative Halbach array 50 shown, portions 52, 54, 56, 58, 60, 62, 64, 66 are arranged such that the orientation of their magnetic field forms a pattern. In the discussion of annular arrays, the terms clockwise and counterclockwise refer to the general direction of the field at the center of portion 52, 54, 56, 58, 60, 62, 64, 66 in relation to array 50. Starting with portion 52 and continuing clockwise, the magnetic field pattern from above is down (portion 52), counterclockwise (portion 54), up (portion 56), clockwise (portion 58), down (portion 60), counterclockwise (portion 62), up (portion 64), clockwise (portion 66). In the illustrative embodiment of FIGS. 8 and 9, the array 50 provides axially oriented magnetic fields including a strong magnetic field side 67 (above the array 50), and an opposite weak magnetic field side 69 (below the array 50). The array 50 may be comprised of more or less portions than shown in FIGS. 8 and 9; however multiples of four portions provide stronger fields because the pattern is not broken.

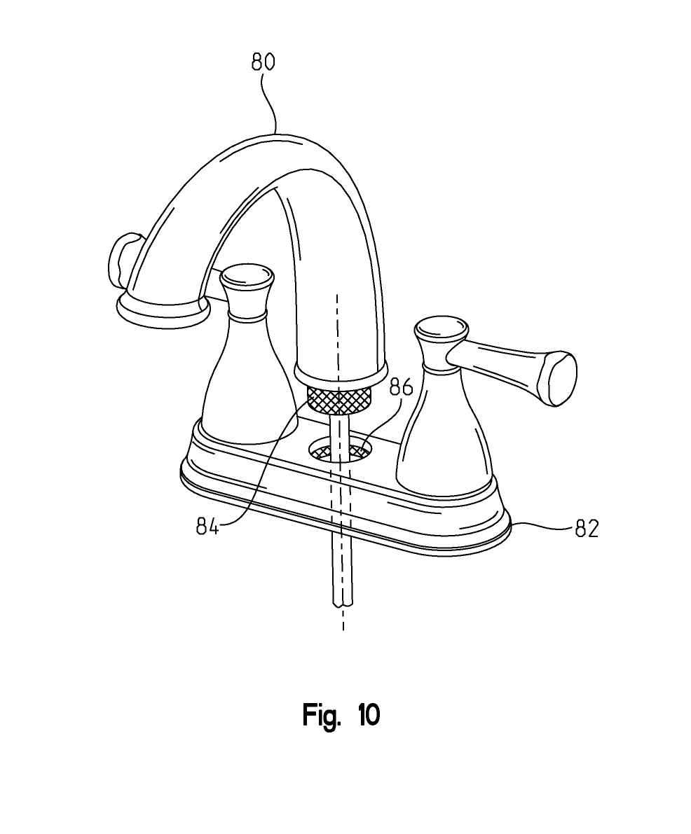

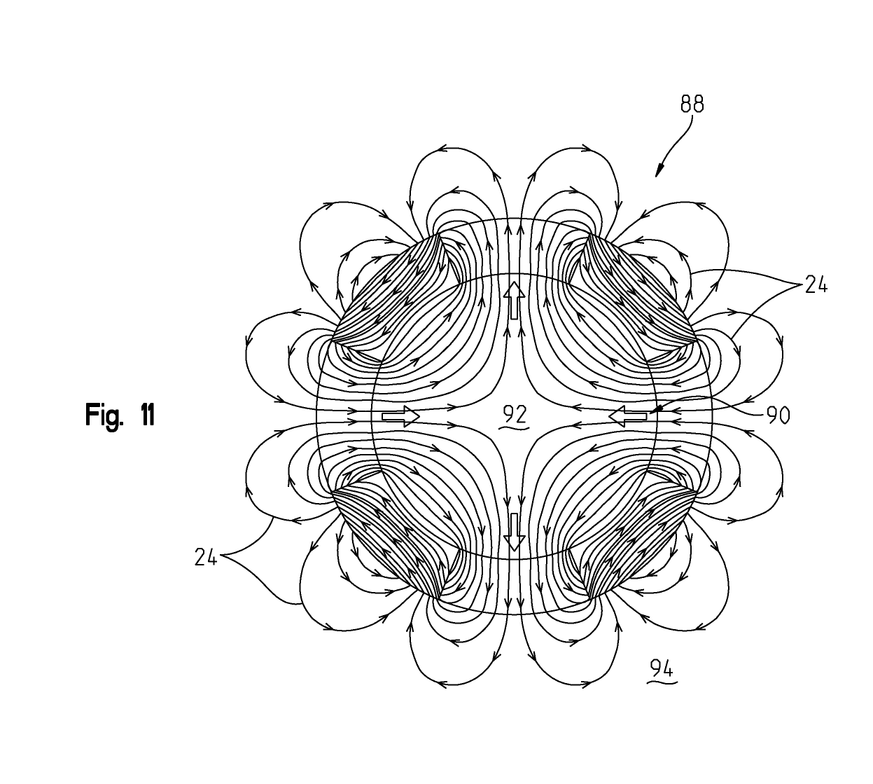

FIG. 10 illustrates another exemplary faucet with a removable fluid delivery device attached to a docking base. In the illustrated embodiment, sprayhead 80 is removably coupled to faucet base 82. Sprayhead element 84 and base element 86 magnetically couple sprayhead 80 to faucet base 82, as in the exemplary designs described above.

FIGS. 11 and 12 are diagrams of exemplary Halbach cylinder arrays 88, 96. Arrays 88, 96 are comprised of a plurality of portions or segments arranged in a cylindrical configuration, each portion having a magnetic field orientation, described consistently with that detailed above. The orientation of the magnetic field for each portion is as given for FIG. 4. The resulting magnetic fields are illustrated by magnetic field lines 24, with the general magnetic field directions represented by arrows 90 as extending in radial directions in a transverse plane.

The portions of array 88, shown in FIG. 11, are arranged to provide an increased magnetic field in the interior 92 of the array and a decreased magnetic field in the exterior 94 of the array. Other orientations for providing an increased interior field are known in the art and may also be used. The portions of array 96, shown in FIG. 12, are arranged to provide an increased magnetic field in the exterior 94 of the array and a decreased magnetic field in the interior 92 of the array. Other orientations for providing an increased exterior field are known in the art and may also be used.

In some embodiments utilizing a cylinder array, a magnetically attractive element may be sized to be positioned in interior 92 of array 90. In other embodiments utilizing a cylinder array, a magnetically attractive element may be sized to be positioned around exterior 98 of array 96. In still other embodiments utilizing a cylinder array, array 88 may be sized to be positioned concentrically around array 96.

While the above illustrative embodiments describe a fluid delivery device releasably coupled to a docking base through a magnetic coupling including a Hallbach array, it should be appreciated that this magnetic coupling may also be used to couple other faucet components. For example, the Hallbach arrays detailed above may be used to couple a faucet handle to a fluid control valve such that rotation of the handle is transferred to a valve stem. Additionally, such illustrative Hallbach arrays may be used to couple trim, such as escutcheons, to faucet mounting bases.

While this invention has been described as having exemplary designs, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

1. A fluid delivery apparatus including:
a first faucet component; and
a second faucet component releaseably coupled to the first faucet component by a magnetic coupling;
wherein the magnetic coupling includes a magnetic array supported by one of the first faucet component and the second faucet component, and a magnetically attractive element supported by the other of the second faucet component and the first faucet component, the magnetic array including a Halbach array having a plurality of magnet portions oriented for providing an increased magnetic field in a first direction and a decreased magnetic field in a second direction, the first direction oriented toward the other of the second faucet component and the first faucet component.

2. The apparatus of claim 1, wherein the first faucet component comprises a docking base, and the second faucet component comprises a fluid delivery device.

3. The apparatus of claim 2, wherein the fluid delivery device is a pullout sprayhead.

4. The apparatus of claim 3, wherein the docking base is one of a spout and a faucet body.

5. The apparatus of claim 2, wherein the fluid delivery device is a hand shower.

6. The apparatus of claim 5, wherein the fluid delivery device is a shower head.

7. The apparatus of claim 1, wherein the magnetically attractive element is at least partially formed from steel or iron.

8. The apparatus of claim 1, wherein the magnetically attractive element includes a second magnet.

9. The apparatus of claim 8, wherein the second magnet includes a Halbach array.

10. The apparatus of claim 1, wherein the Halbach array is a linear Halbach array.

11. The apparatus of claim 1, wherein the first Halbach array is an annular Halbach array.

12. The apparatus of claim 1, wherein the first faucet component comprises a faucet handle, and the second faucet component comprises a fluid control valve.

13. The apparatus of claim 1, wherein the first faucet component comprises a trim, and the second faucet component comprises a faucet mounting base.

14. A faucet comprising:
a spout having opposing first and second ends;
a fluid supply line configured to provide a liquid and slidably received within the spout;
a spray head fluidly coupled to the supply line; and
a magnetic coupling releasably coupling the spray head to second end of the spout;
wherein the magnetic coupling includes a magnetic array supported by one of the spout and the spray head, and a magnetically attractive element supported by the other of the spray head and the spout, the magnetic array including a Halbach array having a plurality of magnet portions oriented for providing an increased magnetic field in a first direction and a decreased magnetic field in a second direction, the first direction oriented toward the magnetically attractive element.

15. The faucet of claim 14, wherein the magnetically attractive element is at least partially formed from steel or iron.

16. The faucet of claim 14, wherein the magnetically attractive element includes a second magnet.

17. The faucet of claim 15, wherein the second magnet includes a Halbach array.

18. The faucet of claim 14, wherein the Halbach array is an annular Halbach array.

19. The faucet of claim 18, wherein the magnet portions include rotating magnetic flux distributions alternating between axial and transverse planes to generate the increased magnetic field in an axial direction toward the other of the spray head and the spout.

20. The faucet of claim 18, wherein the magnet portions include rotating magnetic flux distributions extending within a transverse plane to generate the increased magnetic field in a transverse direction toward the other of the spray head and the spout.

21. A shower head assembly comprising:
a base shower head;
a hand shower removably coupled to the base shower head;
a fluid supply line fluidly coupled to the hand shower;
a plurality of fluid outlets supported by the hand shower; and
a magnetic coupling releasably coupling the hand shower to the base shower head;
wherein the magnetic coupling includes a magnetic array supported by one of the base shower head and the hand shower, and a magnetically attractive element supported by the other of the hand shower and the base shower head, the magnetic array including a Halbach array having a plurality of magnet portions oriented for providing an increased magnetic field in a first direction and a decreased magnetic field in a second direction, the first direction oriented toward the magnetically attractive element.

22. The shower head of claim 21, wherein the Halbach array includes a plurality of linearly aligned magnet portions including rotating magnetic flux distributions extending in alternating x and y directions to generate the increased magnetic filed in a direction toward the other of the hand shower and the base shower head.
